(19) United States
(12) Patent Application Publication
(10) Pub. No.: US 2025/0029402 A1
(43) Pub. Date: Jan. 23, 2025

(54) METHOD AND SYSTEM FOR DETECTING A LANE

(71) Applicant: AGENCY FOR SCIENCE, TECHNOLOGY AND RESEARCH, Singapore (SG)

(72) Inventors: Jiangang WANG, Singapore (SG); Kong Wah WAN, Singapore (SG); Chun Ho PANG, Singapore (SG); Wei Yun YAU, Singapore (SG)

(21) Appl. No.: 18/714,207

(22) PCT Filed: Nov. 23, 2022
(86) PCT No.: PCT/SG2022/050851

§ 371 Date: May 29, 2024

(30) Foreign Application Priority Data
Nov. 29, 2021 (SG) 10202113273Q

(51) Int. Cl. G06V 20/56; G06T 5/60

(52) U.S. Cl. CPC G06V 20/588; G06T 5/60; G06T 2207/30256

(57) ABSTRACT

Method and system for detecting a lane are provided herein. In an embodiment, the method comprises: receiving one or more source detecting images captured by an image capturing device (102) at step S302, the or each of the source detecting images including a source road region having lane features; generating a translated source image corresponding to each of the one or more source detecting images by using a lane feature enhancement module (122) at step S304, with the lane features of the source road region being enhanced in the translated source image; and detecting the lane from the translated source image at S306; wherein the lane feature enhancement module (122) is trained by a plurality of training images and comprises a generator network, to: identify a road region (136) of a corresponding training image of the plurality of training images, translate the road region (136) of the corresponding training image to a translated road region to minimize a loss function that quantifies a dissimilarity between the road region (136) and the translated

### FIELD

The invention relates to a method and system for detecting a lane, in particular, but not exclusively, for use in an autonomous vehicle (AV).

### BACKGROUND

It is common for an AV to perform lane detection with an in-car dash camera, but water puddles on the road or raindrops that remain on the AV's windshield may pose as a nuisance since they may hamper the detectability of lanes in a scene.

Existing approaches for image-based lane detection may be roughly divided into two categories, traditional approach and deep learning approach. However, such existing approaches may not perform well under bad weather conditions, or may be slow and computational-intensive.

It is an object of the present invention to address problems of the prior art and/or to provide the public with a useful choice.

### SUMMARY

According to a first aspect of the present invention, there is provided a method for detecting a lane, the method comprising i) receiving one or more source detecting images captured by an image capturing device, the or each of the source detecting images including a source road region having lane features; ii) generating a translated source image corresponding to each of the one or more source detecting images by using a lane feature enhancement module, with the lane features of the source road region being enhanced in the translated source image; and iii) detecting the lane from the translated source image; wherein the lane feature enhancement module is trained by a plurality of training images and comprises a generator network, to:
a) identify a road region of a corresponding training image of the plurality of training images;
b) translate the road region of the corresponding training image to a translated road region using the generator network to minimize a loss function that quantifies a dissimilarity between the road region and the translated road region to generate the translated source image.

As described in the preferred embodiment, the proposed image-to-image translation method focuses on lane detectability rather than visual quality. Before performing lane detection, the lane feature enhancement module translates the source detecting images to translated source images wherein lane features are enhanced. The image-to-image translation is trained with a loss function focusing on the road region. Such lane-aware approach, when adopted, may bring advantages of improving accuracy of lane detection even when images are captured under rain or bad weather conditions.

In an embodiment of the method for detecting a lane, the generator network may comprise a first generator network and a second generator network inverse the first generator network, and the lane feature enhancement module may be trained to: translate the road region of the corresponding training image to a first translated road region using the first generator network; translate the first translated road region to a second translated road region using the second generator network; and adjust one or more parameters of the lane feature enhancement module to minimize the loss function based on the road region, the first translated road region and the second translated road region. The two generator networks may provide a cycle consistency and may bring advantages that two correct mappings may be learned without collapsing the distributions into single mode.

Preferably, the plurality of training images may comprise a plurality of source training images from a source domain captured in a first weather and a plurality of target training images from a target domain, the plurality of target training images may comprise at least a few target training images captured in the first weather that have one or more lane features being labelled, and the plurality of target training images may further comprise a plurality of unlabelled target training images captured in a second weather. Preferably, a number of the unlabelled target training images is more than a number of the labelled target training images. Introducing labelled target training images captured in the first weather for training the lane enhancement module may help to improve accuracy of translation of the trained module. Overall, providing labelled target raining images captured in the first weather and unlabelled target training images captured in the second weather may bring advantages of improving the efficiency of lane enhancement and accuracy of lane detection. Further, providing more unlabelled target training images than labelled target training images may help to save costs of training the module without compromising the training results.

It is envisaged that the road region may be identified using at least one vanishing point. Using vanishing point to identify road region may help to improve the accuracy of the identification.

Preferably, the image capturing device may be calibrated, and the method may comprise identifying the at least one vanishing point based on an information of a calibration matrix of the image capturing device.

In an embodiment, the at least a few target training images captured in the first weather may be labelled by indicating one or more lane features in white lines.

According to a second aspect of the present invention, there is provided a method for training a lane feature enhancement module for detecting a lane, the lane feature enhancement module comprising a generator network, the method comprising: i) receiving a plurality of training images; ii) identifying a road region of a corresponding training image of the plurality of training images; iii) translating the road region of the corresponding training image to a translated road region using the generator network to minimize a loss function that quantifies a dissimilarity between the road region and the translated road region. Generating a loss function based on the fact that the lanes are on the road for the image-to-image translation network may bring advantages of training the lane feature enhancement module by focusing on the road region. The lane feature enhancement module trained by such method may be used to enhance lane features before lane detection and the accuracy of lane detection may be improved even when images are captured under rain or bad weather conditions.

Preferably, the generator network may comprise a first generator network and a second generator network inverse the first generator network, and the method may further comprise: translating the road region of the corresponding training image to a first translated road region using the first generator network; translating the first translated road region to a second translated road region using the second generator network; and adjusting one or more parameters of the lane feature enhancement module to minimize the loss function based on the road region, the first translated road region and the second translated road region. The two generator networks may provide a cycle consistency and may bring advantages that two correct mappings may be learned without collapsing the distributions into single mode.

It is envisaged that the plurality of training images may comprise a plurality of source training images from a source domain captured in a first weather and a plurality of target training images from a target domain, the plurality of target training images may comprise at least a few target training images captured in the first weather that have one or more lane features being labelled, and the plurality of target training images may further comprise a plurality of unlabelled target training images captured in a second weather. Preferably, a number of the unlabelled target training images is more than a number of the labelled target training images. Introducing labelled target training images captured in the first weather for training the lane enhancement module may help to improve accuracy of translation of the trained module. Overall, providing labelled target raining images captured in the first weather and unlabelled target training images captured in the second weather may bring advantages of improving the efficiency of lane enhancement and accuracy of lane detection. Further, providing more unlabelled target training images than labelled target training images may help to save costs of training the module without compromising the training results.

In an embodiment of the method for training a lane feature enhancement module for detecting a lane, the road region may be identified using at least one vanishing point. Using vanishing point to identify road region may help to improve the accuracy of the identification.

In an embodiment, an image capturing device used for capturing the plurality of training images may be calibrated, and the method may comprise identifying the at least one vanishing point based on an information of a calibration matrix of the image capturing device.

Preferably, the at least a few target training images captured in the first weather may be labelled by indicating one or more lane features in white lines.

According to a third aspect of the present invention, there is provided a system for detecting a lane on a road, comprising: an image capturing device operable to capture one or more images of the road; and a processor configured to detect the lane on the road from the one or more images captured by the image capturing device using a method for detecting a lane, the method comprising i) receiving one or more source detecting images captured by an image capturing device, the or each of the source detecting images including a source road region having lane features; ii) generating a translated source image corresponding to each of the one or more source detecting images by using a lane feature enhancement module, with the lane features of the source road region being enhanced in the translated source image; and iii) detecting the lane from the translated source image; wherein the lane feature enhancement module is trained by a plurality of training images and comprises a generator network, to: a) identify a road region of a corresponding training image of the plurality of training images; b) translate the road region of the corresponding training image to a translated road region using the generator network to minimize a loss function that quantifies a dissimilarity between the road region and the translated road region to generate the translated source image. The system may on the one end capture images of the road and on the other end analyze the captured images for detecting the lane on the road. The method used in the system focuses on lane detectability rather than visual quality. Before performing lane detection, the lane feature enhancement module translates the source detecting images to translated source images wherein lane features are enhanced. The image-to-image translation is trained with a loss function focusing on the road region. Such lane-aware approach, when adopted, may bring advantages of improving accuracy of lane detection even when images are captured under rain or bad weather conditions.

According to a fourth aspect of the present invention, there is provided a vehicle comprising: i) a system for detecting a lane on a road, the system comprising: an image capturing device operable to capture one or more images of the road; and a processor configured to detect the lane on the road from the one or more images captured by the image capturing device using a method for detecting a lane, the method comprising: receiving one or more source detecting images captured by an image capturing device, the or each of the source detecting images including a source road region having lane features; generating a translated source image corresponding to each of the one or more source detecting images by using a lane feature enhancement module, with the lane features of the source road region being enhanced in the translated source image; and detecting the lane from the translated source image; wherein the lane feature enhancement module is trained by a plurality of training images and comprises a generator network, to identify a road region of a corresponding training image of the plurality of training images and translate the road region of the corresponding training image to a translated road region using the generator network to minimize a loss function that quantifies a dissimilarity between the road region and the translated road region to generate the translated source image; and ii) a controller configured to control an operation of the vehicle based on an information of the lane detected by the system. With a system that may perform lane detection well even during bad weather condition such as heavy raining, an operation of the vehicle based on such lane detection may be maintained at a good level in different weather conditions.

According to a fifth aspect of the present invention, there is provided a system for training a lane feature enhancement module for detecting a lane, comprising: i) an image capturing device configured to capture a plurality of training images of a road; ii) a processor configured to perform a method for training a lane feature enhancement module comprising a generator network for detecting a lane, the method comprising: receiving a plurality of training images; identifying a road region of a corresponding training image of the plurality of training images; and translating the road region of the corresponding training image to a translated road region using the generator network to minimize a loss function that quantifies a dissimilarity between the road region and the translated road region; and iii) an output configured to output the lane feature enhancement module.

According to a sixth aspect of the present invention, there is provided a non-transitory computer-readable storage medium storing a computer program, when executed by a processor, performs the method for detecting a lane, the method comprising: i) receiving one or more source detecting images captured by an image capturing device, the or each of the source detecting images including a source road region having lane features; ii) generating a translated source image corresponding to each of the one or more source detecting images by using a lane feature enhancement module, with the lane features of the source road region being enhanced in the translated source image; and iii) detecting the lane from the translated source image; wherein the lane feature enhancement module is trained by a plurality of training images and comprises a generator network, to: a) identify a road region of a corresponding training image of the plurality of training images; b) translate the road region of the corresponding training image to a translated road region using the generator network to minimize a loss function that quantifies a dissimilarity between the road region and the translated road region to generate the translated source image.

According to a seventh aspect of the present invention, there is provided a non-transitory computer-readable storage medium for storing a computer program, when executed by a processor, performs the method for training a lane feature enhancement module comprising a generator network for detecting a lane, the method comprising: i) receiving a plurality of training images; ii) identifying a road region of a corresponding training image of the plurality of training images; iii) translating the road region of the corresponding training image to a translated road region using the generator network to minimize a loss function that quantifies a dissimilarity between the road region and the translated road region.

### BRIEF DESCRIPTION OF THE DRAWINGS

In the following, an embodiment of the present invention including the figures will be described as non-limiting examples with reference to the accompanying drawings in which:

FIG. 1 is a simplified block diagram of a vehicle according to a preferred embodiment and which comprises a lane detection system and a camera;

FIG. 2 illustrates a block diagram of the lane detection system of FIG. 1;

FIG. 3 illustrates a method performed by a processor of the lane detection system of FIG. 2;

FIGS. 4(a)-(h) illustrate examples of source images and corresponding translated images generated by the lane detection system of FIG. 2;

FIG. 5(a) illustrates calibration of the camera of FIG. 1; and FIG. 5(b) illustrates an estimation of a vanishing point based on the calibration of FIG. 5(a);

FIGS. 6(a)-(d) illustrate some samples of training/testing images that may be used to train a lane feature enhancement module used in the method of FIG. 3;

FIG. 7 illustrates a diagram of a method of training the lane feature enhancement module in connection with the method of FIG. 3;

FIG. 8 illustrates a conceptual diagram of the CycleGAN adopted in the training method of FIG. 7;

FIG. 9 illustrates a method of training the lane enhancement module based on the diagram of FIG. 8;

FIGS. 10(a)-(c) illustrate the results of lane feature enhancement of the method of FIG. 3 by unsupervised translation and by semi-supervised translation; and

FIG. 11 illustrates lane feature enhancement and lane detection of the method of FIG. 3 by unsupervised translation and semi-supervised translation.

### DETAILED DESCRIPTION

According to a preferred embodiment, a lane detection system in an autonomous vehicle (AV) is configured to perform a method of detecting a lane from one or more source detecting images captured for a vehicle. Initially, the method comprises receiving one or more source images containing information of a road captured by a camera. Subsequently, a lane feature enhancement module generates a translated image corresponding to each of the one or more source detecting images to enhance lane features of the translated image. Finally, the lane is detected from the one or more generated translated images. Tracking technology may be applied based on the detection of lane to predict the lane from its previous video sequence.

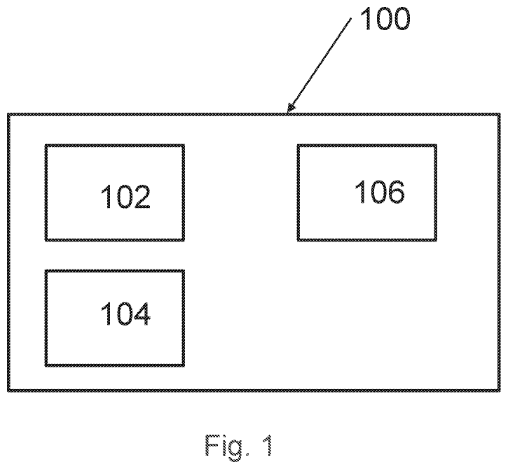

FIG. 1 is a simplified block diagram of the AV 100, for example a car, according to the described preferred embodiment. The AV 100 includes an image capturing device in the form of a camera 102, which is an in-car dash camera in this embodiment. The AV 100 further includes a lane detection system 104, and a controller 106. The camera 102 is configured to capture images or videos of views of the AV 100 for processing by the lane detection system 104. The images and/or videos captured by the camera 102 may be used to provide training images to train the lane feature enhancement module, and to provide source detecting images for detecting lanes. The controller 106 is configured to control an operation of the AV 100 based at least in part on information received from the lane detection system 104, for example in such a way as to control the AV 100 to move on the current lane or change to a neighbouring lane.

As such, the controller 106 may itself comprise further computing devices. The controller 106 may comprise several sub-systems (not shown) for controlling specific aspects of the movement of the AV 100 including but not limited to a deceleration system, an acceleration system and a steering system. Certain of these sub-systems may comprise one or more actuators, for example the deceleration system may comprise brakes, the acceleration system may comprise an accelerator pedal, and the steering system may comprise a steering wheel or other actuator to control the angle of turn of wheels of the AV 100, etc.

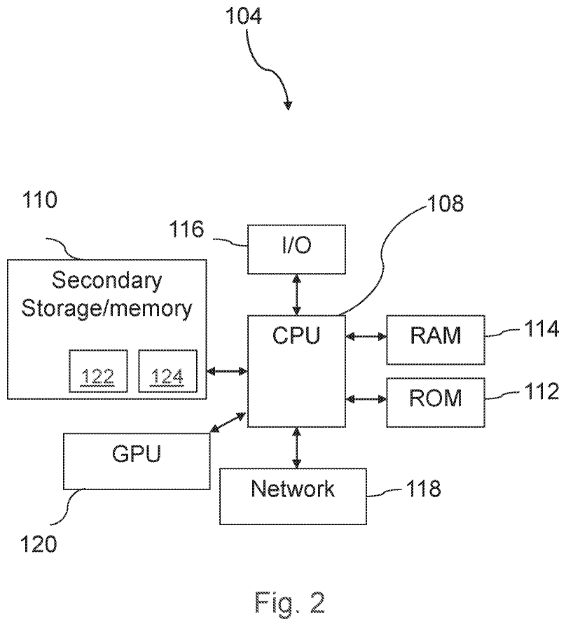

FIG. 2 illustrates the block diagram of the lane detection system 104. The lane detection system 104 includes a processor 108 (which may be referred to as a central processor unit or CPU) that is in communication with memory devices including a secondary storage 110, a read only memory (ROM) 112, a random access memory (RAM) 114, an input/output (I/O) devices 116, a network connectivity devices 118 and a graphics processing unit (GPU) 120, for example a mini GPU. The processor 108 and/or GPU 120 may be implemented as one or more CPU chips. The GPU 120 may be embedded alongside the processor 108 or it may be a discrete unit, as shown in FIG. 2.

It is understood that by programming and/or loading executable instructions onto the lane detection system 104, at least one of the CPU 108, the RAM 114, the ROM 112 and the GPU 120 are changed, transforming the lane detection system 104 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the lane detection system 104 is turned on or booted, the CPU 108 and/or GPU 120 may execute a computer program or application. For example, the CPU 108 and/or GPU 120 may execute software or firmware stored in the ROM 112 or stored in the RAM 114. In some cases, on boot and/or when the application is initiated, the CPU 108 and/or GPU 120 may copy the application or portions of the application from the secondary storage 110 to the RAM 114 or to memory space within the CPU 108 and/or GPU 120 itself, and the CPU 108 and/or GPU 120 may then execute instructions that the application is comprised of. In some cases, the CPU 108 and/or GPU 120 may copy the application or portions of the application from memory accessed via the network connectivity devices 118 or via the I/O devices 116 to the RAM 114 or to memory space within the CPU 108 and/or GPU 120, and the CPU 108 and/or GPU 120 may then execute instructions that the application is comprised of. During execution, an application may load instructions into the CPU 108 and/or GPU 120, for example load some of the instructions of the application into a cache of the CPU 108 and/or GPU 120. In some contexts, an application that is executed may be said to configure the CPU 108 and/or GPU 120 to do something, e.g., to configure the CPU 108 and/or GPU 120 to perform the object detection according to the described embodiment. When the CPU 108 and/or GPU 120 is configured in this way by the application, the CPU 108 and/or GPU 120 becomes a specific purpose computer or a specific purpose machine.

The secondary storage 110 may comprise one or more disk drives or tape drives and is used for non-volatile storage of data and as an over-flow data storage device if the RAM 114 is not large enough to hold all working data. The secondary storage 110 may be used to store programs which are loaded into the RAM 114 when such programs are selected for execution, such as the lane feature enhancement module 122 and a lane detector 124. The ROM 112 is used to store instructions and perhaps data which are read during program execution. The ROM 112 is a non-volatile memory device which typically has a small memory capacity relative to the larger memory capacity of the secondary storage 110. The RAM 114 is used to store volatile data and perhaps to store instructions. Access to both the ROM 112 and the RAM 114 is typically faster than to the secondary storage 110. The secondary storage 110, the RAM 114, and/or the ROM 112 may be referred to in some contexts as computer readable storage media and/or non-transitory computer readable media.

The I/O devices 116 may include a wireless or wired connection to the camera 102 for receiving image data from the camera 102 and/or a wireless or wired connection to the controller 106 for transmitting information regarding the trajectory of a target object so that the controller 106 can control the operation of the AV 100 accordingly. The I/O devices 116 may alternatively or additionally include electronic displays such as video monitors, liquid crystal displays (LCDs), plasma displays, touch screen displays, or other well-known output devices.

The network connectivity devices 118 may enable a wireless connection to facilitate communication with other computing devices such as components of the AV 100, for example the camera 102 and/or controller 106 or with other computing devices not part of the AV 100. The network connectivity devices 118 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. The network connectivity devices 118 may enable the processor 108 and/or GPU 120 to communicate with the Internet or one or more intranets. With such a network connection, it is contemplated that the processor 108 and/or GPU 120 might receive information from the network, or might output information to the network in the course of performing an object detection method according to the described embodiment. Such information, which is often represented as a sequence of instructions to be executed using the processor 108 and/or GPU 120, may be received from and outputted to the network, for example, in the form of a computer data signal embodied in a carrier wave.

Such information, which may include data or instructions to be executed using the processor 108 and/or GPU 120 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 108 and/or GPU 120 executes instructions, codes, computer programs, scripts which it accesses from hard disk, floppy disk, optical disk (these various disk-based systems may all be considered the secondary storage 110), flash drive, the ROM 112, the RAM 114, or the network connectivity devices 118. While only one processor 108 and GPU 120 are shown, multiple processors may be present. Thus, while instructions may be discussed as executed by one processor 108, the instructions may be executed simultaneously, serially, or otherwise executed by one or multiple processors. Instructions, codes, computer programs, scripts, and/or data that may be accessed from the secondary storage 110, for example, hard drives, floppy disks, optical disks, and/or other device, the ROM 112, and/or the RAM 114 may be referred to in some contexts as non-transitory instructions and/or non-transitory information.

In an embodiment, the lane detection system 104 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the lane detection system 104 to provide the functionality of a number of servers that is not directly bound to the number of computers in the lane detection system 104. For example, virtualization software may provide twenty virtual servers on four physical computers. In an embodiment, the functionality according to the described embodiment may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality of the described embodiment may be provided as a computer program product. The computer program product may comprise one or more computer readable storage medium having computer usable program code embodied therein to implement the functionality according to the described embodiment.

The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analogue magnetic tape, compact disk read only memory (CD-ROM) disks, floppy disks, jump drives, digital cards, multimedia cards, and others. The computer program product may be suitable for loading, by the lane detection system 104, at least portions of the contents of the computer program product to the secondary storage 110, to the ROM 112, to the RAM 114, and/or to other non-volatile memory and volatile memory of the lane detection system 104. The processor 108 and/or GPU 120 may process the executable instructions and/or data structures in part by directly accessing the computer program product, for example by reading from a CD-ROM disk inserted into a disk drive peripheral of the lane detection system 104. Alternatively, the processor 108 and/or GPU 120 may process the executable instructions and/or data structures by remotely accessing the computer program product, for example by downloading the executable instructions and/or data structures from a remote server through the network connectivity devices 118. The computer program product may comprise instructions that promote the loading and/or copying of data, data structures, files, and/or executable instructions to the secondary storage 110, to the ROM 112, to the RAM 114, and/or to other non-volatile memory and volatile memory of the lane detection system 104.

In some contexts, the secondary storage 110, the ROM 112, and the RAM 114 may be referred to as a non-transitory computer readable medium or a computer readable storage media. A dynamic RAM embodiment of the RAM 114, likewise, may be referred to as a non-transitory computer readable medium in that while the dynamic RAM receives electrical power and is operated in accordance with its design, for example during a period of time during which the lane detection system 104 is turned on and operational, the dynamic RAM stores information that is written to it. Similarly, the processor 108 and/or GPU 120 may comprise an internal RAM, an internal ROM, a cache memory, and/or other internal non-transitory storage blocks, sections, or components that may be referred to in some contexts as non-transitory computer readable media or computer readable storage media.

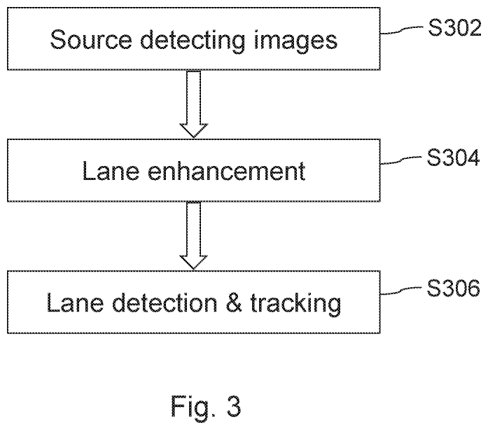

FIG. 3 depicts a method for detecting a lane on an image captured by the camera 102 in the AV 100, the steps of which may be executed by the processor 108 and/or GPU 120 of the lane detection system 104, according to the described embodiment. The lane detection method may be performed real time when the AV 100 is running on a road to provide information to support a control of the AV 100, or it may be performed offline when the AV 100 is not running for any purpose such as maintenance. The method comprising steps S302 to S306 will be described in detail as follows.

In step S302, one or more source detecting images captured by the camera 102 are received by the processor 108 and/or GPU 120 via one of the I/O devices 116 or the network connectivity devices 118. The images captured by the camera 102 may be stored as individual image documents or video documents. Where video documents are stored, images may be extracted from the video documents for processing.

After one or more source detecting images are received by the processor 108 and/or GPU 120, the lane feature enhancement module 122 is used to generate a translated source image corresponding to each of the one or more source detecting images, by performing step S304, which may be collectively called lane-aware image-to-image translation that will be discussed later.

In step S304, for a source detecting image, the lane feature enhancement module 122 translates the source detecting image to a translated source image to enhance one or more lane features of a source road region in the translated source image. The one or more lane features are enhanced by improving contrast between the one or more estimated lane features and a background of the one or more estimated lane features.

To improve the contrast, the brightness of the one or more estimated lane features may be increased while preserving the background of the one or more estimated lane features from the corresponding source detecting image. The road region in the source detecting image may be estimated using a vanishing point as a parameter. The estimated road region defines an area from where lane features are likely to be identified.

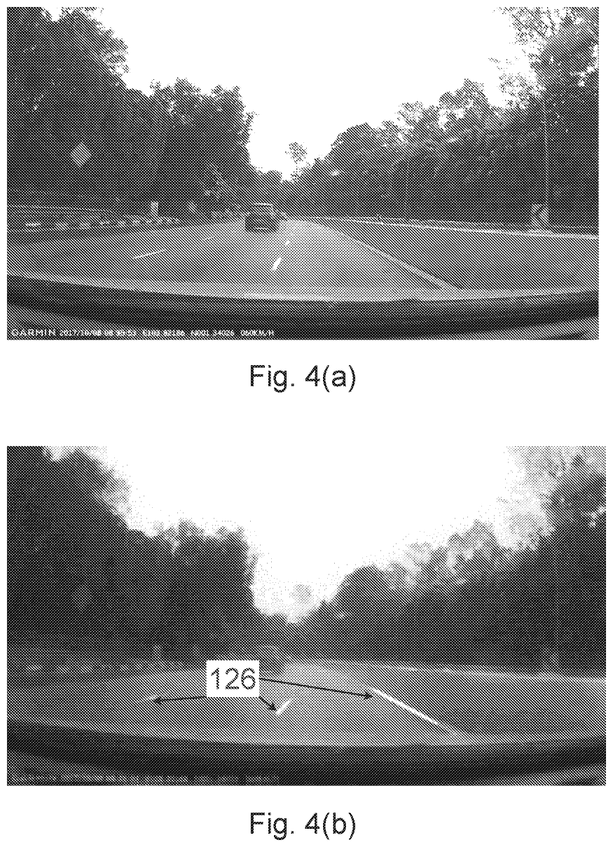

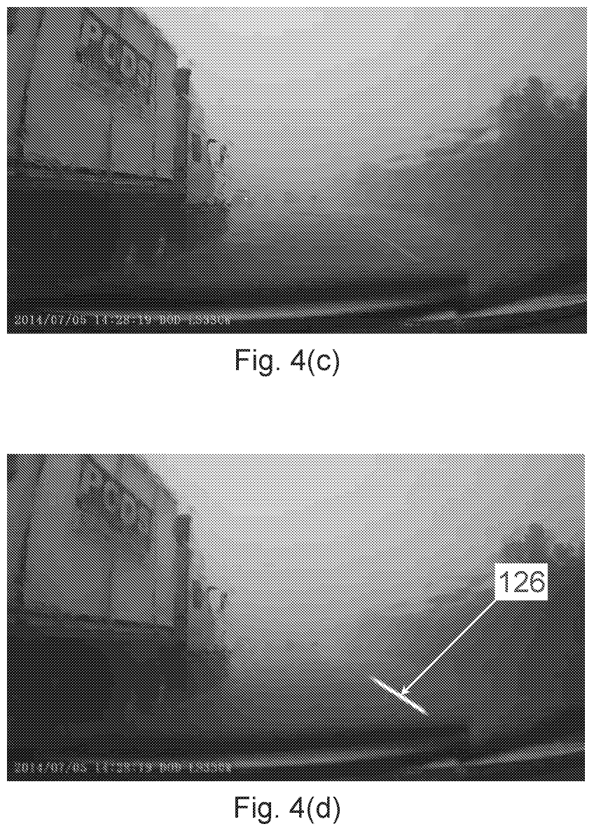

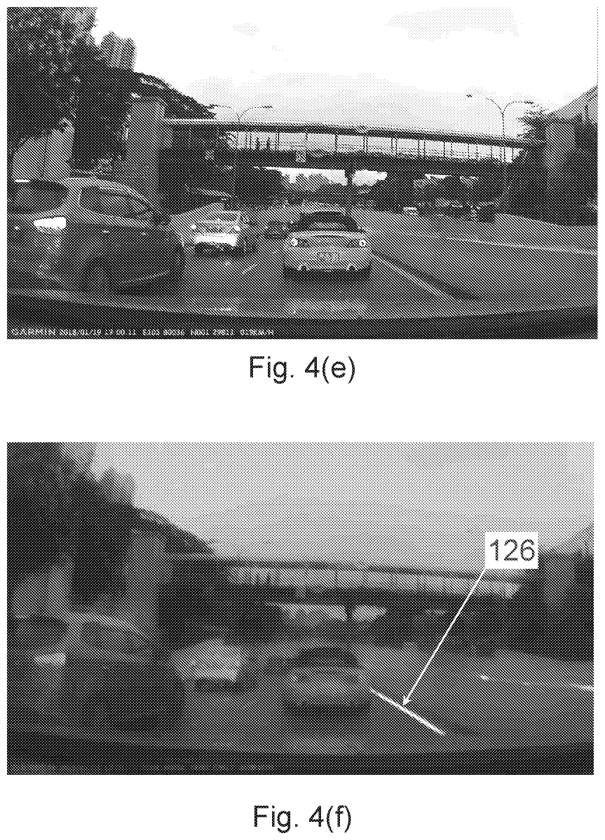

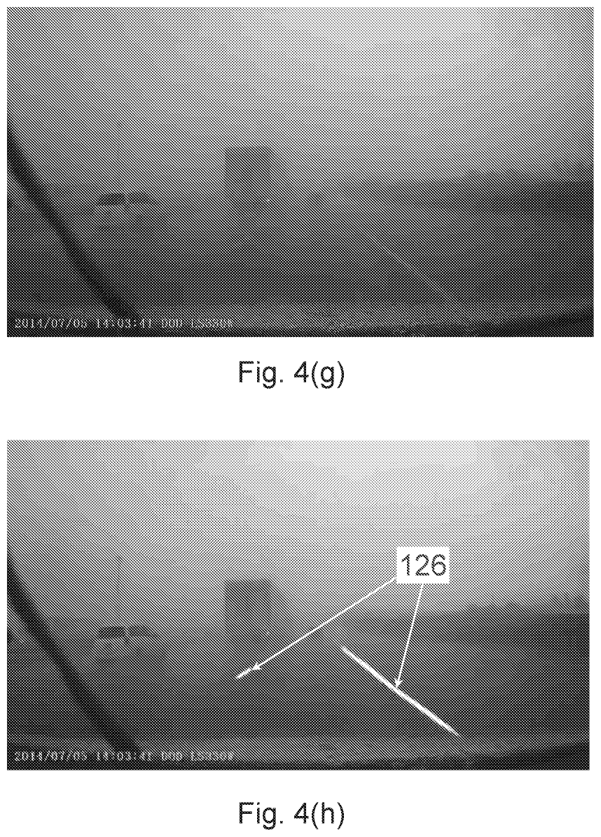

FIGS. 4(a), 4(c), 4(e) and 4(g) depict some examples of source detecting images captured under rain, and FIGS. 4(b), 4(d), 4(f) and 4(h) depict corresponding translated image respectively generated by the lane feature enhancement module 122 trained by a plurality of training images where lane features are enhanced with white thick lines 126 while preserving the background. The lane feature enhancement module 122 will be further discussed in detail later.

In step S306, after the translated image is generated, the lane detector 124 is used to detect one or more lane features on the translated image. The lane detector 124 may be any lane detector that is suitable for detecting a lane, such as a deep learning lane detector (e.g. Vanishing Point Guided Network for Lane and Road Marking Detection and Recognition (VPGNet)), or one that uses a simple detection method (e.g. binarization), etc. The lane detector 124 may perform the lane detection once a translated image is generated or after some translated images are generated. The lane detection results may be used for tracking purpose, such as a current frame of a video sequence may be used to predict the lane in a subsequent frame of the video sequence, which may be helpful where lanes are fully lost due to any reasons, such as a water puddle on the road, raindrops on the windshield or the occlusion caused by the wiper, in practically under heavy rain conditions.

In use, when the AV 100 is in motion, the camera 102 installed in the AV 100 captures images in real time, which are transmitted to the lane detection system 104 for processing. The images may be transmitted to the processor 108 and/or GPU 120 via one of the I/O devices 116 or the network connectivity devices 118 in image document format and/or video document format. The AV 100 may operate in an auto-driving mode or a human-driving mode. When the controller 106 is controlling an operation of the AV 100 in auto-driving mode, the results of lane detection may be used by the controller 106 as a consideration in making any decision in controlling the operation of the AV 100. For example, the controller 106 may control the AV 100 to slow down when the estimated lane features show that the road ahead is crooked; the controller 106 may control the AV 100 to change to another lane in advance to prepare for a turning down the road, at an area where changing lane is allowable. When the AV 100 is in human-driving mode, it may be determined whether to turn on this lane detection function to assist the driver in identifying the road condition and driving condition, such as alert the driver when the AV 100 is running on a lane line.

### Lane-Aware Image-To-Image Translation

In this embodiment, the lane feature enhancement module 122 is a Cycle Generative Adversarial Network (CycleGAN) trained by labelled and unlabeled training images to learn translating or mapping a source image from a source domain, such as an image captured under bad weather conditions with poor or limited visibility, such as rain, fog, or snow, to a target image in a target domain, such as an image with an enhanced lane by improving contrast between one of more lane features with a background of the one of more lane features. A cycle consistency is used for unsupervised image-to-image translation so that two correct mappings is learned without collapsing the distributions into single mode. In this embodiment, the CycleGAN is adopted as a base image-to-image translation network with a modification, namely modified CycleGAN, to explicitly guide the learning to be focused on object-of-interest.

For a general CycleGAN, a generator network is defined as G, X→Y, discriminator D_{Y}, and additional generator network is defined as F: Y→X, discriminator D_{X}, where X and Y are two domains, namely source domain and target domain, respectively. Generative adversarial loss of the generator network is defined as follows:

$$L ( G , F , {D}_{X} , {D}_{Y} ) = {L}_{GAN} ( G , {D}_{Y} , X , Y ) + {L}_{GAN} ( F , {D}_{X} , Y , X ) + λ {L}_{cyc} ( G , F ) \qquad ( 1 )$$

where λ controls the relative importance of the accuracy of each of the two discriminators relative to ability of a corresponding generator of the lane feature enhancement module 122 to “fool” the discriminator:

$${L}_{GAN} ( G , {D}_{Y} , X , Y ) = {E}_{y ∼ p ( y )} [ log ( {D}_{Y} ( y ) ) ] + {E}_{x ∼ p ( x )} [ log ( 1 - {D}_{Y} ( G ( x ) ) ) ] \qquad ( 2 )$$

$${L}_{GAN} ( F , {D}_{X} , Y , X ) = {E}_{x ∼ p ( x )} [ log ( {D}_{X} ( x ) ) ] + {E}_{y ∼ p ( y )} [ 1 - log ( 1 - {D}_{X} ( F ( y ) ) ) ] \qquad ( 3 )$$

$${L}_{cyc} ( G , F ) = {E}_{x ∼ p ( x )} [ {‖ F ( G ( x ) ) - x ‖}_{1} ] + {E}_{y ∼ p ( y )} [ {‖ G ( F ( y ) ) - y ‖}_{1} ] \qquad ( 4 )$$

where x and y are real sample from X and Y, respectively; p(x) and p(y) are distributions for source and target data, respectively.

The learning procedure aims at:

$${G}^{*} , {F}^{*} = {arg}_{G , F}^{min} {}_{{D}_{X} {D}_{Y}}^{max} L ( G , F , {D}_{X} , {D}_{Y} ) \qquad ( 5 )$$

Semi-supervised learning may be understood as using a predictive model in which there are few labelled samples with many of the rest unlabelled. Similarly, semi-supervised GAN is an extension of the GAN architecture for addressing semi-supervised learning problems.

As lanes are on a road, the lane-awareness may be improved using an information that the lanes are on the road. In order to further improve lane-awareness in the general CycleGAN, information of the road region is adopted to generate a new loss function for the image-to-image translation network presented above to come to the modified CycleGAN. The camera 102 may be calibrated, so that calibrating information may be used for estimating road regions. Preferably, the vanishing point, intersection of parallel lanes or intersection of parallel lane features, is adopted to define the new loss function, Lₜ of the modified CycleGAN; the region which is below the vanishing point is used to compute a loss function, L₀ being a constrain of the new loss function, Lₜ which is read as:

$${L}_{t} = L ( G , F , {D}_{x} , {D}_{y} ) + {L}_{0} \qquad ( 6 )$$

where L₀ represents loss enforces to the road region while keeping a background of the road region.

The background of the road region is defined by preserving loss as a pixel-wise weighted I₁-loss where the background is with weight 1 and road are with 0. Only the pixel in the road region in both original and translated images are considered to be translated in cycle. For original (x, Rₓ), (y, R_{y}) and translated (y′, R_{y}), (x′, R^{x}′), where Rₓ, R_{y}, Rₓ′ and R_{y}′ are binary represented road regions,

$${L}_{0} = {‖ w ( {R}_{x} , {{R}_{y}}^{′} ) ⊙ ( x - {y}^{′} ) ‖}_{1} + {‖ w ( {R}_{y} , {{R}_{x}}^{′} ) ⊙ ( y - {x}^{′} ) ‖}_{1} \qquad ( 7 )$$

where L₀ is the background-preserving loss function, w(Rₓ, R_{y}′) and w(R_{y}, Rₓ′) are weight matrices, and ⊙ is the element-wise product.

The weight matrices w(Rₓ, R_{y}′) and w(R_{y}, Rₓ′) in equation (7) are defined as follows:

$$w ( {R}_{x} , {R}_{y}^{′} ) ( i , j ) = \{ \begin{matrix}1 & if ( i , j ) ϵ {R}_{x} and ( i , j ) ϵ {R}_{y}^{′} and {R}_{x} ( i , j ) \neq \\ & {R}_{y}^{′} ( i , j ) \\ 0 & else\end{matrix} for all ( i , j ) on image \qquad ( 8 )$$

$$w ( {R}_{y} , {R}_{x}^{′} ) ( i , j ) = \{ \begin{matrix}1 & if ( i , j ) ϵ {R}_{y} and ( i , j ) ϵ {R}_{x}^{′} and {R}_{y} ( i , j ) \neq \\ & {R}_{x}^{′} ( i , j ) \\ 0 & else\end{matrix} for all ( i , j ) on image \qquad ( 9 )$$

Thus, the background preserving loss function L₀ quantifies a dissimilarity between the original road region Rₓ and the corresponding translated road region R_{y}′ translated by the generator network G, X→Y, and a dissimilarity between the original road region R_{y} and the corresponding translated road region R translated by the additional generator network F: Y→X.

Finally, the optimization presented in equation (5) is modified to:

$${G}^{*} , {F}^{*} = {arg}_{G , F}^{min} {}_{{D}_{X} {D}_{Y}}^{max} {L}_{t} ( G , F , {D}_{X} , {D}_{Y} ) \qquad ( 10 )$$

for the learning procedure of the lane feature enhancement module 122 to aim at.

### Identification of the Vanishing Point

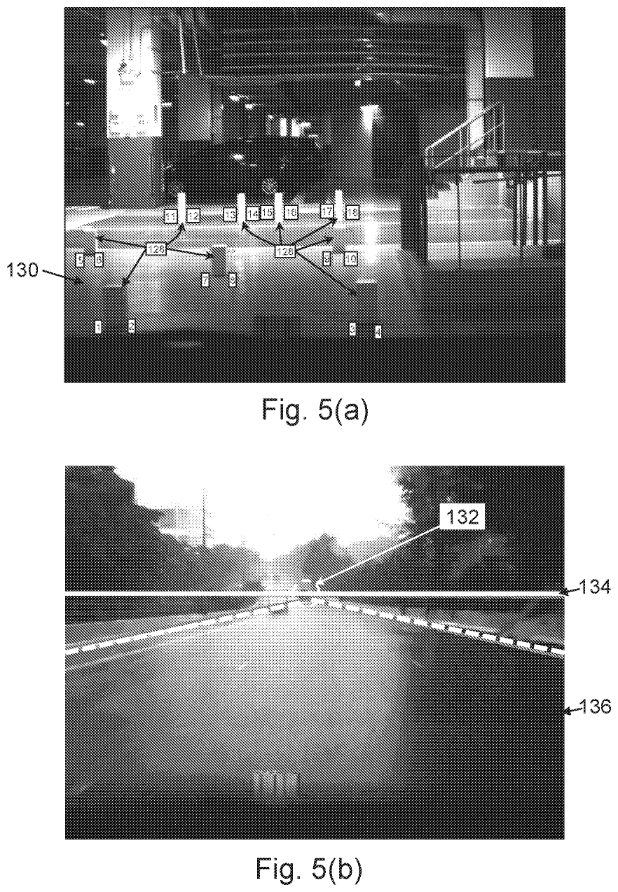

FIG. 5(a) illustrates calibration of the camera 102 of AV100 in an experiment for illustrating how the vanishing point may be identified. As shown in FIG. 5(a), there is a total of nine calibration objects 128 on a ground 130. Two vertices of each of the calibration objects 128 on the ground 130 are labelled consecutively from number 1 to number 18 in FIG. 5(a). Different calibration objects 128 may be selected for the calibration. For example, in this experiment, the four calibration objects 128 with vertices numbers of 1 and 2, 5 and 6, 13 and 14, and 17 and 18 were used to calibrate the camera 102. FIG. 5(b) illustrates the identified vanishing point 132 circled in white dashed lines from the calibration matrix, and a vanishing line 134, the solid white line extending through the identified vanishing point 132, identifying an area below the vanishing line 134 as the road region 136.

To elaborate, in this embodiment, the vanishing point 132 is estimated from a camera calibration matrix. A relationship between the camera 102 and the ground 130 is estimated and the estimation of the relationship between the camera 102 and the ground 130 is formulated as a 2D to 2D transform problem, i.e. the relationship between image and the ground 130. Equation (11) is a planer homograph that transforms coordinates between ground plane and image plane. The transform is represented as a 3×3 projection matrix as follows.

$$[ \begin{matrix}tu \\ tv \\ t\end{matrix} ] = [ \begin{matrix}{a}_{11} & {a}_{12} & {a}_{13} \\ {a}_{21} & {a}_{22} & {a}_{23} \\ {a}_{31} & {a}_{32} & 1\end{matrix} ] [ \begin{matrix}x \\ y \\ 1\end{matrix} ] \qquad ( 11 )$$

where (u,v) and (x, y) are coordinates of a point on image and the ground 130, respectively, aᵢⱼ (i=1,2,3; j=1,2,3, a₃₃=1) are 8 unknown parameters, and t is a parameter for computing the image coordinates from ground coordinates. Equation (11) provides:

$$tu = {a}_{11} x + {a}_{12} y + {a}_{13} \qquad ( 12 )$$

$$tv = {a}_{21} x + {a}_{22} y + {a}_{23} \qquad ( 13 )$$

$$t = {a}_{31} x + {a}_{32} y + 1 \qquad ( 14 )$$

Then the image coordinates will be:

$$u = tu / t \qquad ( 15 )$$

$$v = tv / t \qquad ( 16 )$$

In order to determine the projection matrix, the corresponding coordinates (u, v, x, y) of at least four points are to be determined.

The vanishing point 132 corresponding to the vertical coordinate, v, when x=0, form the above equation (16), the vanishing point 132 arrives at

$$v = \frac{{a}_{21}}{{a}_{31}} \qquad ( 17 )$$

The above-mentioned four calibration objects 128 with vertex numbers of 1 and 2, 5 and 6, 13 and 14, and 17 and 18 are used to compute the relationship between the camera 102 and the ground 130. Once the coordinates of these vertices are read from image (u, v) and ground (x, y), respectively, the parameters aᵢⱼ can be computed by solving a least-square fitting problem. Consequently, the vanishing point 132 may be computed from equation (17).

### Training of the Lane Feature Enhancement Module 122

As described above, the lane feature enhancement module 122 is formulated as an image-to-image translation problem. To address this problem in unsupervised image-to-image translation, i.e. the content or style to be translated need to be learnt from a large database or a database contains simple background; the content-of-interest is made use of explicitly. In this embodiment, as mentioned above, some labelled images are added to the target domain on which the lane features are highlighted in white thick lines which will be discussed later. This allows translation to be trained with fewer images but achieve the comparable or even better results than the unsupervised learning. As there are a few labelled images used to train the translation, the proposed approach belongs to categories of semi-supervised image-to-image translation. The lane feature enhancement module 122 is devised with a semi-supervised image-to-image translation or mapping, it narrows down to one content and one style image which does not make it completely unsupervised as there is only one target style image.

In order to train a rain image translation, data from both the internet and the AV 100 is collected to prepare a large database which contains images of source domain (rain images) and target domain (clear images), respectively. Once images are enhanced, the lane detector 124 is applied to verify the efficiency of the proposed lane enhancement for improving accuracy rate of lane detection. Without loss generality, in this embodiment, a deep learning lane detection approach is adopted. The implementation and training of the lane feature enhancement module 122 based on the modified CycleGAN will be discussed as follows.

In the implementation in this embodiment, the generators, G and F in equation (1), contain three stride-2 convolutions, six residual blocks and three fractionally stridden convolutions. Similar patch-level discriminators, Dx and Dy in equation (1), are applied. λ in equation (1) is set to be 10 for balancing the two objectives in equations (2) and (3). A total of 200 epochs is set. The networks are trained from scratch with an initial learning rate of 0.0002, which decays to zero after the first 100 epochs.

To better test the effectiveness of the proposed approach, videos and images taken under heavy rain (e.g. 5 mm rainfall per hour) are to be treated as source data for preparing training data images, which will be further discussed below. There is no publicly available benchmark database for evaluating lane detection under rain conditions. In this embodiment, a database is prepared using videos collected using the camera 102 in the AV 100 under heavy rain (a gauge may be used to measure the rain rate when collecting data), and videos retrieved readily from the internet. A plurality of images is extracted from the videos to be used as training images.

The images in source domain (A) are rain images and the images in target domain (B) comprise images to be translated from the source domain. The target domain contains two kinds of images: (1) clear images collected under good visibility, such as images captured in a sunny day, which are unlabeled; (2) rain images collected under rain, which are manually labelled by indicating lane features in the images in white thick lines which will be further discussed below. Although a few images are labelled with the remainder unlabeled, it is not required that the images from the two domains are paired, like the case for supervised image-to-image translation. The image-to-image translation may be guided to focus on the contents and regions of interest.

During learning, a test set is defined to evaluate the training performance. The images of the source and target domains are then grouped as TrainA, TestA, TrainB and TestB, respectively.

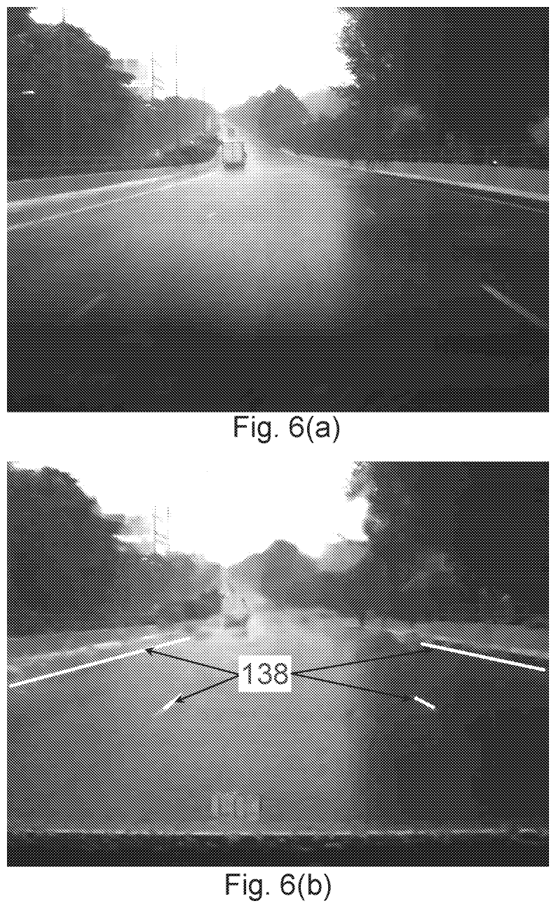

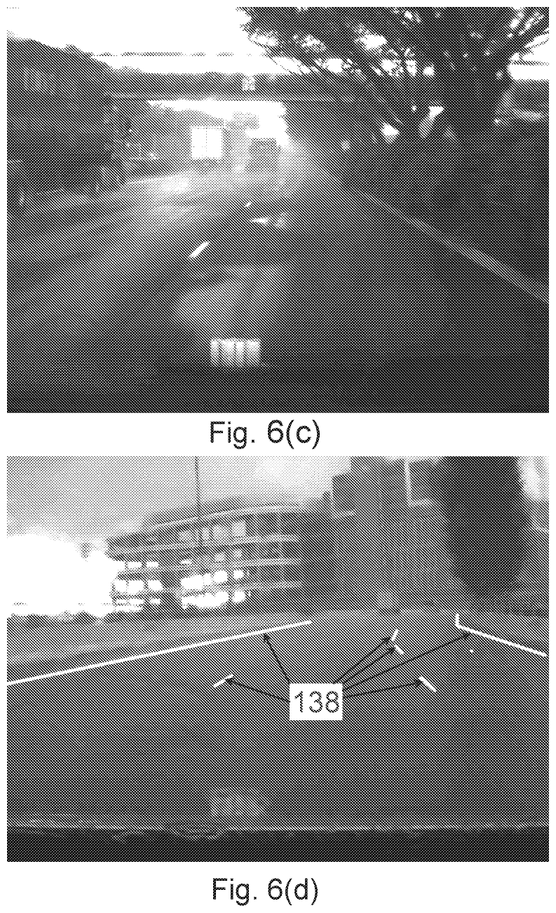

In this experiment, the semi-supervised learning, the source domain (A) contains 50 TrainA images and 41 TestA images, the target domain (B) contains 118 TrainB images and 109 TestB images, respectively, wherein 41 images from the TestB images and 50 images from the TrainB images are labelled. FIGS. 6(a)-(d) show some samples of TrainA, TrainB, TestA and TestB respectively. FIG. 6(a) shows a sample image of group TrainA, which is a rain image to be translated. FIG. 6(b) shows a sample image from group TrainB, which is a rain image labelled by highlighting lane lines in white thick lines 138. FIG. 6(c) shows a sample image of group TestA, which is a rain image to be translated. FIG. 6(d) shows a sample image of group TestB, which is a rain image labelled by highlighting lane lines in white thick lines 138.

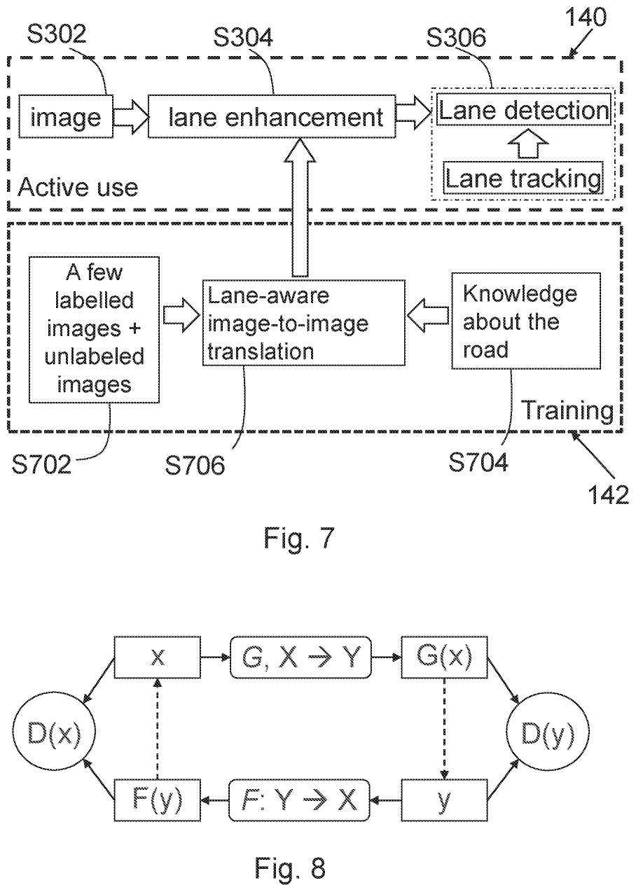

FIG. 7 illustrates a diagram of a method of training the lane feature enhancement module 122 in connection with the lane detecting method of FIG. 3. FIG. 7 comprises an upper part 140 illustrating the active use of the trained lane feature enhancement module 122 corresponding to the method of FIG. 3, and a lower part 142 illustrating training of the lane feature enhancement module 122, which will be described as below.

In step S702, a plurality of training images is received as the basis for training. The plurality of training images comprises a plurality of source training images from a source domain captured under heavy rain as mentioned before, at least a few labelled target training images having one or more lane features labelled from a target domain captured under heavy rain, and a plurality of target training images from a target domain captured in a good visibility, such as in a sunny day. As described above, the training images may be divided into different training and testing groups as needed.

In step S704, knowledge about the road is input to the lane feature enhancement module 122 to constrain the training of the lane feature enhancement module 122. As set out in equations (6) to (9), the road region 136 is used to define the loss function L₀ which in consequence is used to constrain the loss function Lₜ.

In step S706, the lane feature enhancement module 122 is trained by minimizing a discriminability between the generated translated images and the target training images from the target domain.

FIG. 8 illustrates a conceptual diagram of the training of the lane feature enhancement module 122 based on modified CycleGAN. The generator network G, X→Y maps a source image x (or F(y), as the case may be) to a translated image G(x) for discriminator D(y) to determine whether the translated image G(x) is a “real” target image or a “fake” target image. Similarly, the additional generator network F: Y→X maps a target image y (or G(x), as the case may be) for the discriminator D(x) to determine whether the translated image F(y) is a “real” source image or a “fake” source image. As a function of mapping an image from one domain to another domain, the generators identify at least one road region in a source training image from the source domain, identify one or more lane features based on the at least one identified road region, and improve a contrast between the one or more identified lane features and a background of the one or more identified lane features. Training is conducted to minimize a discriminability between the generated translated images and the target training images from the target domain to eventually achieve the optimization presented in equation (10).

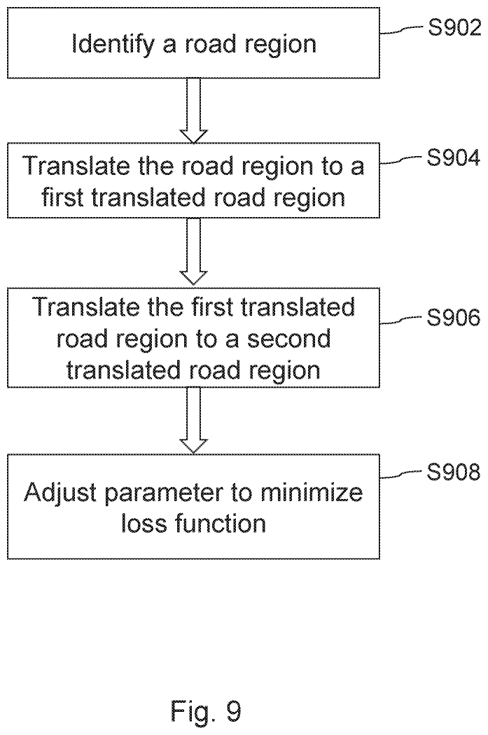

Further, as part of the equation (10), the loss function L₀ defined by the road region 136 introduces lane awareness to the lane enhancement module 122, guiding the learning to the road region 136. A method of training the lane enhancement module 122 based on FIG. 8 is further illustrated in FIG. 9, focusing on minimizing the loss function defined by the road region 136. In this embodiment, the lane feature enhancement module 122 is trained by the plurality of training images. For a corresponding training image of the plurality of training images, the follow steps are executed to train the lane feature enhancement module 122 focusing on the road region 136.

In step S902, the road region 136 of the corresponding training image is identified. For example, the road region 136 may be identified using the vanishing point 132, and the vanishing point 132 may be identified through calibration matrix of the image capturing device 102.

In step S904, the identified road region 136 of the corresponding training image is translated to a first translated road region of a first translated training image using a first generator network. For example, the generator network G, X→Y may be considered as the first generator network.

In step S906, the first translated road region is translated to a second translated road region of a second translated training image using a second generator network. For example, the additional generator network F: Y→X may be considered as the second generator network.

In step S908, one or more parameters of the lane feature enhancement module 122 is adjusted to minimize the loss function L₀, defined in equation (7), that quantifies a dissimilarity between the road region 136 and the first translated road region and a dissimilarity between the first translated road region and the second translated road region. By minimizing the loss function L₀ defined by the road region 136, lane-aware is introduced to the lane feature enhancement module 122, so that a translation done by the lane feature enhancement module 122 is focused on the road region 136.

Parameters of the lane feature enhancement module 122 are adjusted during training of the lane feature enhancement module 122. After the training is completed, the parameters are fixed, and the lane feature enhancement module 122 may then be used in steps S304 of FIG. 3.

### Advantages of the Proposed Semi-Supervised Lane-Aware Approach

The training of both supervised and unsupervised image-to-image translations are heavily dependent on the training images, and the unsupervised image-to-image translation problem is considered more challenging due to lack of corresponding images. For static images, while the object of interest (foreground, to be translated) can be learnt from a large training database, the background might be affected which could lead to a lower detectability. Separately, the road region is hard to be segmented from the images under bad weather conditions, therefore, methods like instance GAN using segmented instance to define loss function may not perform well under bad weather conditions.

The image enhancement proposed in the described embodiment is formulated as an image-to-image translation problem, and the semi-supervised technique is devised to efficiently learn from an image set containing images from source domain (rain images) and target domain (clear images). The semi-supervised translation may make the output indistinguishable from reality while enhancing the lane detection ability. Further, this semi-supervised translation is an efficient approach which may automatically learn the loss function appropriate for improving the efficiency.

The lane feature enhancement module 122 may enhance the lane while preserving the background. This may improve the detectability of lanes even when the visibility is poor, such as under rain. The contrast between the lane features and background of the lane features may be improved. Although attention-guided network could be an approach to solve this problem, when AV 100 moves, the dynamic change of the background leads to the failure of attention adaptation. Furthermore, the movement of the wipers in rain makes the wipers becoming a part of foreground instead of background, which makes the problem even more challenging. It is not practical to train a GAN-based image-to-image translation with limited images. Providing some labelled images to guide the training procedure may help to narrow down the content to be translated.

The loss function defined by the road region 136 enforces lane-aware image generation. As a result of translation done by the lane feature enhancement module 122, new rain images may be generated by highlighting the lane features explicitly in white thick lines 126. Results show that using only a few labelled images, the proposed semi-supervised learning may still be able to enhance lanes efficiently and improving lane detection significantly.

Overall, the proposed semi-supervised image-to-image translation serves to enhance lane features while preserve background, which may be used to address the challenging issue of lane detection under poor or limited visibility, such as rain, fog and snow etc.

### Comparison of Results Between Existing Approach and the Proposed Approach

Conventional methods proposed an instance-aware image-to-image translation where the instance is represented as vehicle segmentation mask. It aims to solve the problem when image translation faces multiple instances which have significant changes in shape. The method works well, however, the requirement of segmentation mask could be challenging when images are captured under heavy rain conditions. Similarly, mask contrast-GAN and Attention-GAN require segmentation mask that are not applicable for an application under rain. Attention-guided unsupervised approach has been proposed which is able to learn content-of-interest by adding attention network to generation as well as discrimination networks. They aim at a translation that the content-of-interest can be translated while preserving the background. However, for AVs, the scenes that are captured by the in-car camera change from frame to frame when the vehicle is in motion. In addition, wiper movement in the rain could cause false positives as well because of the same reason. Experiments are conducted to verify the effectiveness and efficiency of the proposed semi-supervised approach. The unsupervised image-to-image translation is used for comparison with the present semi-supervised image-to-image translation.

The semi-supervised translation is trained using the TrainA, TestA, TrainB and TestB described above to achieve the optimization presented in equation (10). For unsupervised learning, TrainA and TestA are the same with that of semi-supervised learning, except that there are 5,068 images in TrainB and 1,068 images in TestB, to achieve the optimization presented in equation (10).

The image detection results of unsupervised translation are compared with that of the present semi-supervised translation. Experiment is also conducted to compare the lane detection accuracy with and without lane enhancement.

For verifying effectiveness, translated images of different approaches with lane features being enhanced are compared. For verifying the efficiency of the proposed semi-supervised translation, an unsupervised image-to-image translation is implemented. The results of the semi-supervised translation are compared with the results of the unsupervised translation in the database. In order to guide the learning focus on content-of-interest, an attention network is added to both generative adversarial network and discriminative adversarial network. The contents to be translated can be learned while the background is preserved. However, under rain conditions, the dynamic change of the images captured from in-car camera cannot be ignored. The movements of the vehicle as well as wiper makes the wipers or water on the road being translated and finally detected as lanes besides the real lanes. In other words, the wipers or water on the road are not part of the background under rain conditions.

As the semi-supervised approach is envisaged to improve lane detection accuracy, the lane detection rate is used to measure the enhancement quality. Without loss of generality, in this embodiment, a conventional lane detector is adopted. It is a network with eight layers to perform four tasks: grid regression, object detection, multi-label classification, and vanishing point prediction.

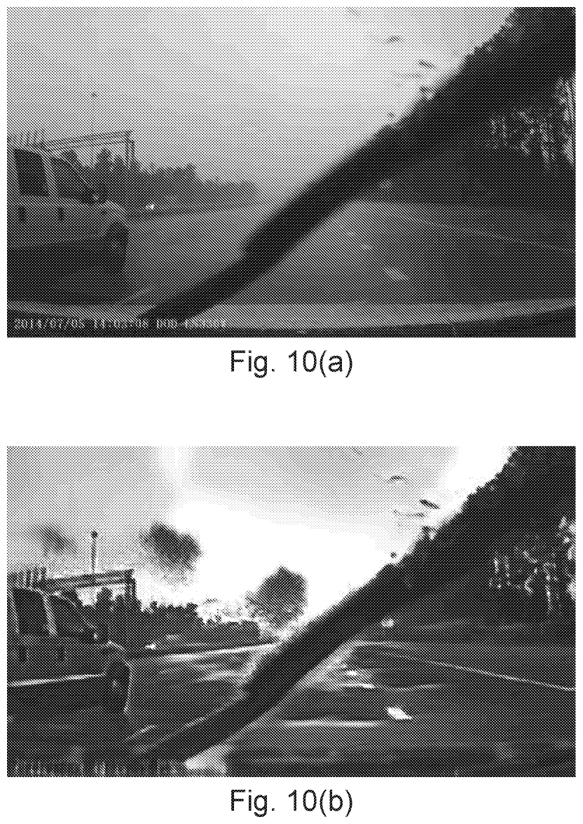

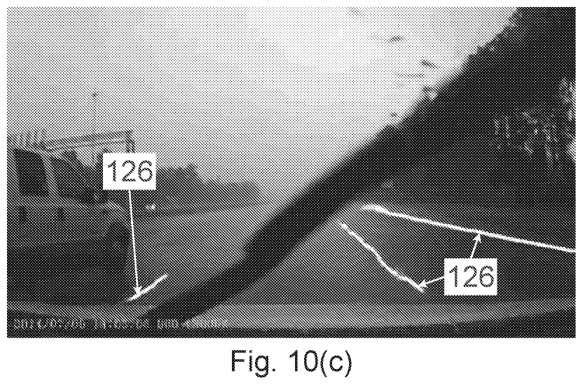

The comparison between the lane enhancements is shown in FIG. 10. FIG. 10(a) shows the original images to be processed. FIG. 10(b) shows the images translated by the unsupervised image-to-image translation, with parts of the image being enhanced. From the enhancement results of the unsupervised learning, it can be seen that some contents from the background are enhanced besides the lane features. FIG. 10(c) shows the enhancement results of the semi-supervised translation. As can be seen from FIG. 10(c), only lane features are enhanced and highlighted in white thick lines 126 by the proposed semi-supervised translation.

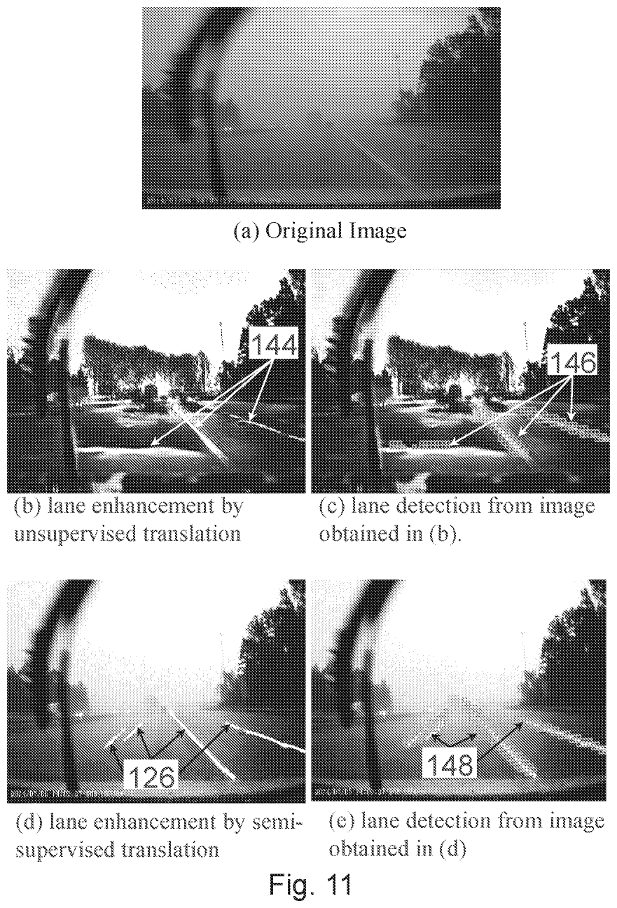

FIGS. 11(a)-(e) illustrate a comparison example of lane feature enhancement and lane detection between unsupervised translation, and the proposed semi-supervised translation. FIG. 11(a) shows the original image to be processed. FIG. 11(b) shows the translated image generated by the unsupervised translation with lane enhancement. FIG. 11(c) shows the lane detection results based on FIG. 11(b). As can be seen from FIG. 11(b), the unsupervised translation enhanced some features in white shapes 144, but some of that are not correct lane features, hence the lane detection results based on such lane enhancement is not accurate as shown in grid 146. FIG. 11(d) shows the translated image generated by the semi-supervised translation with lane enhancement, it can be seen that the false positive for unsupervised learning caused by the water on the road is prevented in the semi-supervised learning, and the white thick lines 126 in FIG. 11(d) is very close to the actual lane lines. Lane detection based on lane enhancement of FIG. 11(d) is shaded in grid 148 in FIG. 11(e), which is evidently much better than the result in FIG. 11(c). The lanes are explicitly indicated in the training set and this influences and guides the learning to locate the object of interest to be translated efficiently.

The quantitative analysis of the present approach has been done on a large database which includes images from road-driving video collected by the AV 100 or from internet. The number of the frames and the lane detection accuracy on the database are illustrated in Tables I to III. Tables I and II are the detection rates obtained from the images enhanced by the present semi-supervised image-to-image translation and unsupervised image-to-image translation, respectively. The detection accuracy on the original images (without enhancement) are reported in Table III.

By comparing the results, it can be seen that the semi-supervised approach can achieve 4% to 7% improvement of the lane detection accuracy to the unsupervised approach. The semi-supervised learning has much better performance than unsupervised learning to prevent missing of the lanes. Both unsupervised and semi-supervised approaches can improve detection significantly than the original images (without enhancement).

TABLE I
Lane detection results with the present semi-supervised image-
to-image translation based on road driving video collected
by the AV 100 and from internet in rain condition

| | | | | Wrong and | |
|---|---|---|---|---|---|
| Videos | Source | Frames | Detected | Missing | Accuracy |
| 1 | AV collected | 363 | 317 | 46 | 0.87 |
| 2 | AV collected | 586 | 529 | 57 | 0.90 |
| 3 | Youtube | 3,700 | 3,219 | 481 | 0.87 |
| Total | | 4,649 | 4,065 | 584 | 0.87 |

TABLE II
Lane detection results with the unsupervised image-
to-image translation on the same database as Table I

| | | | | Wrong and | |
|---|---|---|---|---|---|
| Videos | Source | Frames | Detected | Missing | Accuracy |
| 1 | AV collected | 363 | 268 | 95 | 0.74 |
| 2 | AV collected | 586 | 478 | 108 | 0.82 |
| 3 | YouTube | 3,700 | 3,097 | 603 | 0.84 |
| Total | | 4,649 | 3,843 | 806 | 0.83 |

TABLE III
Lane detection results without lane enhancement
on the same database as Table I

| | | | | Wrong and | |
|---|---|---|---|---|---|
| Videos | Source | Frames | Detected | Missing | Accuracy |
| 1 | AV collected | 363 | 129 | 234 | 0.36 |
| 2 | YouTube | 586 | 169 | 417 | 0.29 |
| 3 | YouTube | 3,700 | 1,258 | 2,442 | 0.34 |
| total | | 4,649 | 1,556 | 3,093 | 0.33 |

The experimental results on the data collected from internet and the AV 100 have verified that the proposed semi-supervised learning can achieve better lane enhancement than the unsupervised learning and the lane detection rate can be improved significantly after the images are enhanced with the semi-supervised image-to-image translation.

Although the lane detection system 104 is shown as a separate module in FIG. 1, it is envisaged that it may form part of the controller 106.

It is envisaged that the image capturing device can be any type of camera that is suitable for capturing image in car, particularly when the car is in motion, for example an in-car dash camera. It is envisaged that GigE cameras may be used to support high speed transmission of data.

Although in the described embodiment, the vanishing point 132 is estimated using a camera calibration matrix, it is envisaged that other vanishing point estimation methods may be used.

Although in the described embodiment, CycleGAN network model is employed to generate the translated images, it is envisaged that other models capable of mapping images from one domain to another domain, and which may not require the training images from the two domains to be paired may be adopted.

While in the described embodiment, the lane features are labelled or enhanced by indicating in white thick lines, it is envisaged that other methods of improving contrast between an area and a background of the area may be used as long as the contrast is improved. For example, the lines may be highlighted in other color, the highlight may not be in a line shape, but in other shape, such as a rectangular empty box.

1. A method for detecting a lane, comprising:
i) receiving one or more source detecting images captured by an image capturing device, each of the one or more source detecting images including a source road region having lane features;
ii) generating a translated source image corresponding to each of the one or more source detecting images by using a lane feature enhancement module, with the lane features of the source road region being enhanced in the translated source image; and
iii) detecting the lane from the translated source image;
wherein the lane feature enhancement module is trained by a plurality of training images and comprises a generator network, to:
a) identify a road region of a corresponding training image of the plurality of training images;
b) translate the road region of the corresponding training image to a translated road region using the generator network to minimize a loss function that quantifies a dissimilarity between the road region and the translated road region to generate the translated source image.

2. The method of claim 1, wherein the generator network comprises a first generator network and a second generator network inverse the first generator network, and the lane feature enhancement module is trained to:
translate the road region of the corresponding training image to a first translated road region using the first generator network;
translate the first translated road region to a second translated road region using the second generator network; and
adjust one or more parameters of the lane feature enhancement module to minimize the loss function based on the road region, the first translated road region and the second translated road region.

3. The method according to claim 1, wherein the plurality of training images comprises a plurality of source training images from a source domain captured in a first weather and a plurality of target training images from a target domain, the plurality of target training images comprises at least a few target training images captured in the first weather that have one or more lane features being labelled, and the plurality of target training images further comprises a plurality of unlabelled target training images captured in a second weather.

4. The method according to claim 3, wherein a number of the unlabelled target training images is more than a number of the labelled target training images.

5. The method according to claim 1, wherein the road region is identified using at least one vanishing point.

6. The method according to claim 5, wherein the image capturing device is calibrated, and the method comprises identifying the at least one vanishing point based on an information of a calibration matrix of the image capturing device.

7. The method according to claim 3, wherein the at least a few target training images captured in the first weather is labelled by indicating one or more lane features in white lines.

8. A method for training a lane feature enhancement module for detecting a lane, the lane feature enhancement module comprising a generator network, the method comprising:
i) receiving a plurality of training images;
ii) identifying a road region of a corresponding training image of the plurality of training images;
iii) translating the road region of the corresponding training image to a translated road region using the generator network to minimize a loss function that quantifies a dissimilarity between the road region and the translated road region.

9. The method of claim 8, wherein the generator network comprises a first generator network and a second generator network inverse the first generator network, and the method further comprises:
translating the road region of the corresponding training image to a first translated road region using the first generator network;
translating the first translated road region to a second translated road region using the second generator network; and
adjusting one or more parameters of the lane feature enhancement module to minimize the loss function based on the road region, the first translated road region and the second translated road region.

10. The method according to claim 8, wherein the plurality of training images comprises a plurality of source training images from a source domain captured in a first weather and a plurality of target training images from a target domain, the plurality of target training images comprises at least a few target training images captured in the first weather that have one or more lane features being labelled, and the plurality of target training images further comprises a plurality of unlabelled target training images captured in a second weather.

11. The method according to claim 10, wherein a number of the unlabelled target training images is more than a number of the labelled target training images.

12. The method according to claim 8, wherein the road region is identified using at least one vanishing point.

13. The method according to claim 12, an image capturing device used for capturing the plurality of training images is calibrated, and the method comprises identifying the at least one vanishing point based on an information of a calibration matrix of the image capturing device.

14. The method according to claim 8, wherein the at least a few target training images captured in the first weather is labelled by indicating one or more lane features in white lines.

15. (canceled)

16. A vehicle, comprising:
i) a system for detecting a lane on a road; and
ii) a controller configured to control an operation of the vehicle based on an information of the lane detected by the system,
wherein the system comprises:
an image capturing device operable to capture one or more images of the road; and
a processor configured to detect the lane on the road from the one or more images captured by the image capturing device using a method for detecting a lane according to claim 1.

17.-19. (canceled)
